(19) United States
(12) Patent Application Publication
(10) Pub. No.: US 2003/0192299 A1
(43) Pub. Date: Oct. 16, 2003

(54) Wear resistant chain

(76) Inventors: Arimasa Kaga, Osaka (JP); Toshifumi Satoh, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/400,244

(22) Filed: Mar. 27, 2003

(30) Foreign Application Priority Data
Apr. 10, 2002 (JP) 107958/2002

(51) Int. Cl. B65G 17/38; B21L 11/00

(52) U.S. Cl. 59/5; 59/9; 59/35.1; 198/850

(57) ABSTRACT

A wear resistant chain, which smoothly articulates and slides for a long period of time without generating unusual wear elongation even if used together with an extremely deteriorated lubricating oil having a high degree of oxidation, has both ends of a bushing are force-fit into bushing holes of a pair of inner plates respectively and both ends of a connecting pin which is rotatably mounted into the bushing are force-fit into pin holes of a pair of outer plates disposed on both of the outer sides of the pair of inner plates. The bushing uses the base material of one steel selected from an austenite stainless steel, a martensite stainless steel, a precipitation-hardening steel, a high-carbon chromium bearing steel and an alloy tool steel each subjected to heat curing.

### TECHNICAL FIELD TO WATCH THE INVENTION PERTAINS

The present invention relates to bushing chains and roller chains, which are used in power transmission mechanisms or carrying mechanisms in vehicles and industrial machines and the like.

### BACKGROUND OF THE INVENTION

As power transmission media used in power transmission mechanisms of vehicles metallic bushing chains and roller chains have been recently increasingly adopted in place of toothed belts, which have often been used from the demands of high load, high speed and making maintenance free.

A conventional chain, for example a bushing chain is formed/such that both ends of a cylindrical bushing are force-fit into bushing holes of a pair of inner plates respectively and both ends of a connecting pin rotatably mounted into the bushing are force-fit into pin holes of a pair of outer plates disposed on both of the outer sides of the pair of inner plates. Further, a bushing chain is formed such that a roller is rotatably mounted on a bushing of a bushing chain.

In these types of conventional chains as the base material of a connecting pin and a bushing a chromium-molybdenum alloy steel or a high carbon steel containing of carbon of 0.7-1.1% by weight has been used from viewpoints of easy availability and material costs. Then the surfaces of the connecting pins are subjected to surface treatment such as carburizing or carbonitriding to suppress wear of the connecting pin.

Further, to improve wear resistance by forming sprayed layer of ceramics or the like on the surface of a connecting pin and the inner surface of a bushing has also been proposed (see Japanese patent application No. 2000-121311).

However, in the above-mentioned bushing chain or roller chain, it has been reported that in spite of the surface treatment or the formation of a sprayed layer on the surface of the connecting pin or the surface of the bushing, a few chains can exist which do not exhibit an expected resistance. Such chains wear unusually when used in a timing chain or the like of a car. Therefore, the overcoming of unusual wear elongation of a chain to improve further reliability of an engine was an urgent task. Wear elongation occurs when components of the chain show wear, and the components become loose, which causes the chain to elongate and become loose on the sprockets which drive the chain. Thus, the present inventors have studied the task seriously and have found that the unusual wear elongation of the chain is generated by the facts that a lubricating oil in an engine compartment is extremely deteriorated and, after the oxidation of the lubricating oil, has a pH of 3.0 or less, the inner surface of the bushing is corroded by a lubricating oil having a high degree of oxidation whereby the wear in the inner surface of the bushing is accelerated. Further, the present inventors have found that when the materials of the connecting pin and the bushing are the same the both are liable to be adhered to each other so that wear is further accelerated.

Accordingly, the objects of the present invention are to solve the above-mentioned problems that conventional chains have and to provide a wear resistant chain, which smoothly articulates and slides for a long period of time without generating unusual wear elongation even if used together with an extremely deteriorated lubricating oil having a high degree of oxidation.

### SUMMARY OF THE INVENTION

According to a first embodiment of the present invention, said objects are attained by a wear resistant chain in which both ends of a bushing are force-fit into bushing holes of a pair of inner plates respectively and both ends of a connecting pin rotatably mounted into said bushings are force-fit into pin holes of a pair of outer plates disposed on both of the outer sides of said pair of inner plates characterized in that said bushing uses the base material of one steel selected from an austenite stainless steel, a martensite stainless steel, a precipitation-hardening steel, a high-carbon chromium bearing steel and an alloy tool steel each subjected to heat curing. Here, said heat curing is not limited to a specific heat curing, but known heat curing usually used as the surface curing of steel material can be used. However, since there is a difference in effects of the respective heat curing between the base materials, it is preferred to select the types of heat curing in accordance with the base materials to be used. Concretely, for an austenite stainless steel a Tuftride process, called as salt bath softening nitriding, which is one of nitriding processes, is suitable, and for a martensite stainless steel a carburizing hardening process is suitable.

According to a second embodiment of the present invention, said objects are attained by a wear resistant chain in which both ends of a bushing are force-fit into bushing holes of a pair of inner plates respectively and both ends of a connecting pin rotatably mounted into said bushings are force-fit into pin holes of a pair of outer plates disposed on both of the outer sides of said pair of inner plates characterized in that a coating of at least one selected from TiN, CrN, DLC, Al₂O₃, Mo, TiAlN, TiC, TiCN, AlN, Si₃N₄, SiC and NiP is formed on at least the inner surface of said bushing. Here, DLC means a carbon coating having properties similar to that of diamond (known as diamond-like amorphous carbon).

According to a further embodiment of the present invention, in addition to the first and second embodiments of the invention, said objects are attained by the fact that a metallic hard coating containing at least one metal selected from Cr, V, Nb, Ti, Zr, Ta, Mo and W is coated on a surface of said connecting pin. Here, as the metallic hard coating, coatings of metallic carbide, metallic nitride, metallic oxide, metallic carbon nitride and the like can be used. However, from viewpoints of ease of film coating, an affinity for the base material and the like, a coating of metallic carbide is particularly preferable.

According to an additional feature of the present invention, in any of previously described embodiments of the invention, said objects are attained by the fact that said connecting pin and said bushing use different materials from each other as the base material.

According to the wear resistant chain of the first embodiment, as the base material of a bushing, one steel is used, which is selected from an austenite stainless steel, a martensite stainless steel, a precipitation-hardening steel, a high-carbon chromium bearing steel and an alloy tool steel each subjected to heat curing. Accordingly, oxidation resistance of the bushing is enhanced and a chain is smoothly articulated and slid for a long period of time without generating unusual wear elongation even in an oxidizing atmosphere.

According to the wear resistant chain of the second embodiment of the present invention, a coating of at least one material selected from TiN, CrN, DLC, Al₂O₃, Mo, TiAlN, TiC, TiCN, AlN, Si₃N₄, SiC and NiP is formed on at least the inner surface of the bushing. Accordingly, oxidation resistance of the bushing is enhanced and a chain is smoothly articulated and slid for a long period of time without generating unusual wear elongation even in an oxidizing atmosphere.

According to another feature, in addition to the action exerted by the wear resistant chain having steel components or coated components, a metallic hard coating containing at least one metal selected from Cr, V, Nb, Ti, Zr, Ta, Mo and W is coated on a surface of said connecting pin. Accordingly, oxidation resistance of the bushing is further enhanced and a chain is further smoothly articulated and slid for a long period of time without generating unusual wear elongation even in an oxidizing atmosphere.

According to the wear resistant chain of the present invention, where the base material of the connecting pin is different from the base material of the bushings, in addition to the action exerted by the wear resistant chain of the present invention, the adhesion between the connecting pin and the bushing is suppressed and the developing of unusual wear elongation in an oxidizing atmosphere is also suppressed whereby a chain is further smoothly articulated and slid for a long period of time.

### BRIEF DESCRIPTION OF THE DRAWINGS

FIG. 1 is a perspective view showing a part of a wear resistant chain of the present invention; and

FIG. 2 is a graph showing test results of wear resistance of the wear resistant chain of the present invention.

### DESCRIPTION OF THE PREFERRED EMBODIMENTS

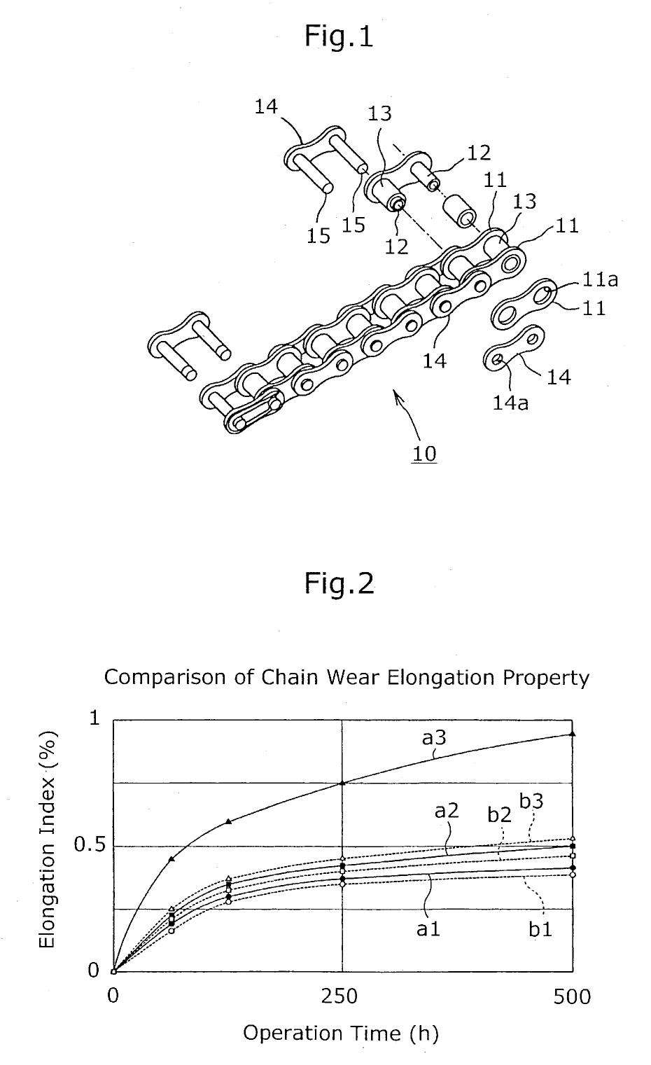

Embodiments of the present invention will now be described based on Examples 1 and 2 with reference to FIGS. 1 and 3.

FIG. 1 is a perspective view showing one example of a wear resistant chain of the present invention. In the wear resistant chain 10 both ends of a bushing 12 are force-fit into bushing holes 11a of a pair of inner plates 11 respectively and both ends of a connecting pin 15 rotatably mounted into said bushings 12 are force-fit into pin holes of a pair of outer plates 14 disposed on both of the outer sides of said pair of inner plates 11. Then a roller is rotatably mounted on said bushing 12. In FIG. 1, as can be understood an assembly structure of a chain perspective views of respective parts of the chain are shown together with the entire perspective view of the chain. Although the wear resistant chain shown in FIG. 1 is a roller chain in which the roller 13 was rotatably fitted around the bushing 12, the wear resistant chain of the present invention is not limited to the roller chain and a bushing chain having no roller may be used.

Here, in Example 1, as the base material of the bushing 12a SUS 304 (18% Cr-8% Ni), which is an austenite stainless steel, was used and the base material was subjected to a Tuftride process, called as salt bath soft-nitriding, which is one of nitriding processes. Further, in Example 2, as the base material of the bushing 12 a SCM 435, which is a conventional chromium-molybdenum alloy steel, was used and the inner surface of the bushing 12 was subjected to nickel-phosphorus (NiP) alloy plating by an electroless plating process. In this case, as the material of connecting pins 15, inner plates 11 and outer plates 14 in Examples 1 and 2, a conventional chromium-molybdenum alloy steel (SCM 435) subjected to a carbonitriding process was used.

FIG. 2 shows test results of wear elongation properties in a usual atmosphere and an oxidizing atmosphere (pH=3) of wear resistant chains of Examples 1 and 2. The tests were carried out by wrapping a wear resistant chain having a link number of 96 around two sprockets having tooth numbers of 18 and 36, rotating the sprockets at 6500 rpm while keeping tension at 0.5 kN, and by measuring the indexes (%) of elongation of the chains. In FIG. 2, the solid lines shown by al to a3 show results of wear resistant chains of Examples 1 and 2 and a conventional wear resistant chain in an oxidizing atmosphere, respectively. Further, the broken lines shown by b1 to b3 show results of wear resistant chains of Examples 1 and 2 and a conventional wear resistant chain in a usual atmosphere, respectively.

As can be understood from FIG. 2, in an unusual atmosphere, large differences cannot be found between the elongation indexes in Examples 1 and 2 and the conventional example. However, in an oxidizing atmosphere, the elongation index of the conventional wear resistant chain is deteriorated two times or more the case in the usual atmosphere. On the other hand, the elongation indexes of Examples 1 and 2 are not almost changed. Namely, it has been confirmed that even in a case where a lubricating oil was extremely oxidized and deteriorated, the wear resistant chain of either of Examples 1 and 2 does not generate unusual wear elongation and smoothly articulates and slides for a long period of time.

Here, as the material of the bushing an austenite stainless steel SUS 304 was used in the above-mentioned Example 1, the same results as in the above-described cases could be obtained in cases where other materials such as a SUS 316, a SUS 410 and a SUS 440, which are martensite stainless steels, a SUS 630, a SUS 631, which are precipitation-hardening stainless steels, a SUJ2, which is a high-carbon chromium bearing steel and a SKD 11, which is an alloy tool steel were used.

Further, in Example 2, the bushing 12 having the same base material as in a conventional case, on whose inner surface a coating of nickel-phosphorus (NiP) alloy plating was coated, was used. However, even when as the coating material TiN, CrN, DLC, Al₂O₃, Mo, TiAlN, TiC, TiCN, AlN, Si₃N₄, or SiC was used, the same results as in the case of NiP could be obtained. Further, although the coating was performed on the inner surface of the bushing 12, which makes slide-contact with the connecting pin, the entire surface of the bushing 12 may be subjected to coating. In particular, in the case of such a roller chain as shown in FIG. 1, wear due to the sliding contact between the inner surface of a roller and the outer surface of a bushing can be more preferably suppressed by coating the entire bushing with a coating.

Further, by forming such a coating as described in Example 2 on a surface of the base material described in Example 1, the wear resistance of a chain in an oxidizing atmosphere can be further improved. Further, in addition to the configuration of the wear resistant chain described in Example 1 or 2, by forming a metallic hard coating containing at least one metal selected from Cr, V, Nb, Ti, Zr, Ta, Mo and W on a surface of the connecting pin. Here, as the metallic hard coating a coating of metallic carbide, metallic nitride, metallic oxide, metallic carbon nitride or the like can be used. However, from the viewpoints of easiness of forming a coating, affinity for the base material and the like, a metallic carbide coating is particularly preferable. As processes of forming a coating, well known processes such as a diffusion coating process and the like can be applied.

Further, continuous load tests have shown that even if the wear resistant chain described in Example 1 is subjected to sliding on sprockets at high speed and high load for a long period of time until the base material of the chain reaches high temperature, conventional adhesion between a connecting pin and a bushing is not generated. It is assumed that this is because in the wear resistant chain of Example 1 the base materials of the connecting pin and the bushing are made of different metallic materials and the distance between crystal lattices of the both materials are different from each other whereby diffusion jointing in a contact interface is difficult to occur. This assumption can be supported by the results that although the wear resistant chain of Example 2 cannot endure high-speed, heavily loaded continuous load tests to the extent of the wear resistant chain of Example 1.

### Effects of the Invention

As described above, the wear resistance chain of the first embodiment of the present invention, as the base material of a bushing, one steel is used, which is selected from an austenite stainless steel, a martensite stainless steel, a precipitation-hardening steel, a high-carbon chromium bearing steel and an alloy tool steel each subjected to heat curing. Accordingly, oxidation resistance of the bushing is improved and the chain does not generate unusual wear elongation even in an oxidizing atmosphere.

According to the wear resistant chain of the second embodiment of the present invention, a coating of at least one material selected from TiN, CrN, DLC, Al₂O₃, Mo, TiAlN, TiC, TiCN, AlN, Si₃N₄, SiC and NiP is formed on at least the inner surface of the bushing. Accordingly, oxidation resistance of the bushing is improved and the occurrence of unusual wear elongation of the chain in an oxidizing atmosphere is suppressed.

Further, according to the present invention, in addition to the effects exerted by the wear resistant chain discussed above, a metallic hard coating containing at least one metal selected from Cr, V, Nb, Ti, Zr, Ta, Mo and W is coated on a surface of said connecting pin. Accordingly, oxidation resistance of the bushing is further enhanced and unusual wear elongation in an oxidizing atmosphere can be avoided.

Additionally, according to the present invention, in addition to the effects exerted by the wear resistant chain of the present invention discussed above, the base material of said connecting pin is different from the base material of said bushing. Accordingly, the adhesion between the connecting pin and the bushing is suppressed and the developing of wear elongation can be avoided. Therefore, unusual wear elongation in the oxidizing atmosphere can be avoided for a long period of time.

1. A wear resistant chain comprising a bushing having two ends, a pair of inner plates having bushing holes, said bushing ends being force-fit into said bushing holes, a pair of outer plates having pin holes, and a connecting pin, said connecting pin rotatably mounted in said bushing and having two ends force-fit into said pin holes, said pair of outer plates being disposed on the outer sides of said inner plates, wherein said bushing has a base material of one steel selected from an austenite stainless steel, a martensite stainless steel, a precipitation-hardening steel, a high-carbon chromium bearing steel and an alloy tool steel each subjected to heat curing.

2. A wear resistant chain according to claim 1, wherein the base material of said connecting pin is different from the base material of said bushing.

3. A wear resistant chain according to claim 1, wherein a metallic hard coating containing at least one metal selected from Cr, V, Nb, Ti, Zr, Ta, Mo and W is coated on a surface of said connecting pin.

4. A wear resistant chain according to claim 3, wherein the base material of said connecting pin is different from the base material of said bushing.

5. A wear resistant chain comprising a bushing having two ends, a pair of inner plates having bushing holes, said bushing ends being force-fit into said bushing holes, a pair of outer plates having pin holes, and a connecting pin having two ends, said connecting pin being rotatably mounted in said bushing and both ends of said connecting pin being force-fit into said pin holes, said pair of outer plates being disposed on the outer sides of both of said inner plates, wherein a coating of at least one material selected from TiN, CrN, DLC, Al₂O₃, Mo, TiAlN, TiC, TiCN, AlN, Si₃N₄, SiC and NiP is formed on at least the inner surface of said bushing.

6. A wear resistant chain according to claim 5, wherein the base material of said connecting pin is different from the base material of said bushing.

7. A wear resistant chain according to claim 5, wherein a metallic hard coating containing at least one metal selected from Cr, V, Nb, Ti, Zr, Ta, Mo and W is coated on a surface of said connecting pin.

8. A wear resistant chain according to claim 7, wherein the base material of said connecting pin is different from the base material of said bushing.
